(19) United States
(12) Patent Application Publication
(10) Pub. No.: US 2024/0237609 A1
(43) Pub. Date: Jul. 18, 2024

(54) Vehicle Pet Ramp Device

(71) Applicant: Michael Thompson, Charlotte, NC (US)

(72) Inventor: Michael Thompson, Charlotte, NC (US)

(21) Appl. No.: 18/460,782

(22) Filed: Sep. 5, 2023

Related U.S. Application Data
(60) Provisional application No. 63/439,381, filed on Jan. 17, 2023.

(51) Int. Cl. A01K 1/035; B60R 3/00

(52) U.S. Cl. CPC A01K 1/035; B60R 3/007

(57) ABSTRACT

A vehicle pet ramp device is provided. The device can be stored in a cargo space of a vehicle wherein a ramp of the device can be deployed to allow a pet to walk into the trunk of the vehicle from a ground surface. A top surface of the device is comprised of a padding to allow the pet to comfortably sit or lay on the device once they have walked into the cargo area. When not in use, the ramp can be folded or telescoped/retracted into an interior space of the housing. The ramp may be repositionable via a hinge and may also be comprised of at least one side rail to prevent a pet from falling off the ramp during use.

### CROSS-REFERENCE TO RELATED APPLICATION

The present application claims priority to, and the benefit of, U.S. Provisional Application No. 63/439,381, which was filed on Jan. 17, 2023, and is incorporated herein by reference in its entirety.

### FIELD OF THE INVENTION

The present invention relates generally to the field of vehicle ramps. More specifically, the present invention relates to a vehicle pet ramp device that allows a pet to easily enter a cargo area of a vehicle from a ground surface, and wherein the device can be easily stored in the cargo area of a vehicle. Accordingly, the present disclosure makes specific reference thereto. Nonetheless, it is to be appreciated that aspects of the present invention are also equally applicable to other like applications, devices, and methods of manufacture.

### BACKGROUND

Traveling with pets can be a difficult experience, especially for elderly pets. Older dogs may have trouble jumping up into a truck or SUV and need to be picked up and moved. Larger dogs can be heavy and cause serious injury to their owner if they need to be constantly picked up and placed into a truck or SUV.

Therefore, there exists a long-felt need in the art for a device that aids a pet in walking into a vehicle. More specifically, there exists a long-felt need in the art for a vehicle pet ramp device that allows a pet to easily walk into the cargo area of a vehicle. In addition, there exists a long-felt need in the art for a vehicle pet ramp device that allows a pet to easily walk into the cargo area of a vehicle and wherein the device provides a place for the pet to sit or lay within the vehicle.

The subject matter disclosed and claimed herein, in one embodiment thereof, comprises a vehicle pet ramp device. The device is primarily comprised of housing with a padded top surface and a ramp that can be extended from and retracted into the housing. The device allows a pet to easily walk into the trunk of a vehicle. The ramp is also comprised of at least one side wall that prevents a pet from falling off the ramp during use. In addition, a top surface of the ramp is comprised of a material that improves walking traction. The ramp may be foldable/telescopic such that it can be stored within the housing when not in use. Once a pet has walked into the trunk, the pet can sit or lay on the customized and laser measured padded top surface of the housing, and the ramp is then retracted into the housing.

In this manner, the vehicle pet ramp device of the present invention accomplishes all the foregoing objectives and provides a device that aids a pet in walking into a vehicle. More specifically, the device allows a pet to easily walk into the trunk of a vehicle via the ramp. In addition, the device also provides a place for the pet to sit or lay within the vehicle via the padded top surface.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle pet ramp device primarily comprised of housing with a padded top surface and a multiple ramp system that can be extended from and retracted into the housing. The device allows a pet to easily walk into the cargo space of a vehicle.

The housing may be any shape customized and laser measured, such that it fits within the cargo space or bed of a vehicle. The top surface of the housing is preferably comprised of a padding or a cushioning. The top surface serves as an area where a pet can sit or lie within the cargo space. The padding is preferably removably attached to the top surface via at least one fastener to allow the padding to be removed for easy cleaning.

The housing is comprised of at least one opening that allows the ramp to be pulled from or retracted into the interior space of the housing during use. In one embodiment, the ramp attaches to at least one internal frame member within the interior space. The frame member is preferably attached to a movable rack within the interior space that allows the ramp to be pulled out from and pushed back into the housing. In one embodiment, the track is a spring-loaded track that facilitates the assisting of extending/retracting the ramp.

The ramp allows a pet to travel from a ground surface into the cargo space of the vehicle via walking. The ramp may articulate a plurality of angles via at least one attachment hinge that connects the ramp to the internal frame member. The top surface of the ramp is comprised of at least one traction material that allows a pet to obtain adequate grip while walking on the ramp. The ramp may also be comprised of at least one side rail that prevents a pet from falling off the ramp while traveling up the ramp. The ramp preferably has a telescopic/retractable ramp body or a folding ramp body to allow the ramp to be easily stored within the interior space when not in use.

The present invention is also comprised of a method of using the device. First, a device is provided comprised of a housing with a top surface comprised of a padding and an interior space, and a ramp that attaches to the housing. Then, a user can place the housing within a cargo area of a vehicle. Next, a user can pull the ramp out of an interior space of the housing via a handle of the ramp and place the ramp on a ground surface. Then, the side rail can be unfolded upward such that it stands vertically in relation to the ramp. After a pet has walked up the ramp, a user can fold the side rail such that it rests flat against the ramp and the ramp can be pushed back into the interior space of the housing.

Accordingly, the vehicle pet ramp device of the present invention is particularly advantageous as it provides a device that aids a pet in walking into a vehicle. More specifically, the device allows a pet to easily walk into the cargo area of a vehicle via the ramp. In addition, the device also provides a place for the pet to sit or lay within the vehicle via the padded top surface. In this manner, the vehicle pet ramp device provides a solution to allow large pets to easily walk into the cargo area of a vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle pet ramp device of the present invention while in a vehicle cargo space with the ramp extended in accordance with the disclosed architecture;

FIG. 2 illustrates a perspective view of one potential embodiment of a vehicle pet ramp device of the present invention while in a vehicle cargo space with the ramp retracted in accordance with the disclosed architecture; and

FIG. 3 illustrates a flowchart of a method of using one potential embodiment of a vehicle pet ramp device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that aids a pet in walking into a vehicle. More specifically, there exists a long-felt need in the art for a vehicle pet ramp device that allows a pet to easily walk into the cargo space of a vehicle. In addition, there exists a long-felt need in the art for a vehicle pet ramp device that allows a pet to easily walk into the cargo space of a vehicle and wherein the device provides a place for the pet to sit or lay within the vehicle.

The present invention, in one exemplary embodiment, is comprised of a vehicle pet ramp device. The device is primarily comprised of a housing with a padded top surface and a ramp that can be extended from and retracted into the housing. The device allows a pet to easily walk into the cargo space of a vehicle. The housing may be any shape, such that it fits within the trunk or bed of a vehicle. The top surface of the housing is preferably comprised of a padding or a cushioning that allows a pet to sit or lay within the cargo space. The padding is preferably removably attached to the top surface via at least one fastener to allow the padding to be removed for easy cleaning.

The housing is comprised of at least one opening that allows the ramp to be pulled from or retracted into the interior space of the housing during use. In one embodiment, the ramp attaches to at least one internal frame member within the interior space. The frame member is preferably attached to a movable rack within the interior space that allows the ramp to be pulled out from and pushed back into the housing. In one embodiment, the track is a spring-loaded track that facilitates the assisting of extending/retracting the ramp.

The ramp allows a pet to travel from a ground surface into the cargo space of the vehicle via walking. In addition, the ramp may articulate a plurality of angles via at least one attachment hinge that connects the ramp to the internal frame member. The top surface of the ramp is comprised of at least one traction material that allows a pet to obtain adequate grip while walking on the ramp. The ramp may also be comprised of at least one side rail that prevents a pet from falling off the ramp while traveling up the ramp. The ramp preferably has a telescopic ramp body or a folding ramp body to allow the ramp to be easily stored within the interior space when not in use.

The present invention is also comprised of a method of using the device. First, a device is provided comprised of a housing with a top surface comprised of a padding and an interior space, and a ramp that attaches to the housing. Then, a user can place the housing within a cargo space of a vehicle. Next, a user can pull the ramp out of an interior space of the housing via a handle of the ramp and place the ramp on a ground surface. Then, the side rail can be unfolded upward, such that it stands vertically in relation to the ramp. After a pet has walked up the ramp, a user can fold the side rail, such that it rests flat against the ramp, and the spring loaded ramp can be pushed back into the interior space of the housing.

Accordingly, the vehicle pet ramp device of the present invention is particularly advantageous as it provides a device that aids a pet in walking into a vehicle. More specifically, the device allows a pet to easily walk into the cargo space of a vehicle via the ramp. In addition, the device also provides a place for the pet to sit or lay within the vehicle via the padded top surface. In this manner, the vehicle pet ramp device provides a solution to allow large pets to easily walk into the cargo space of a vehicle.

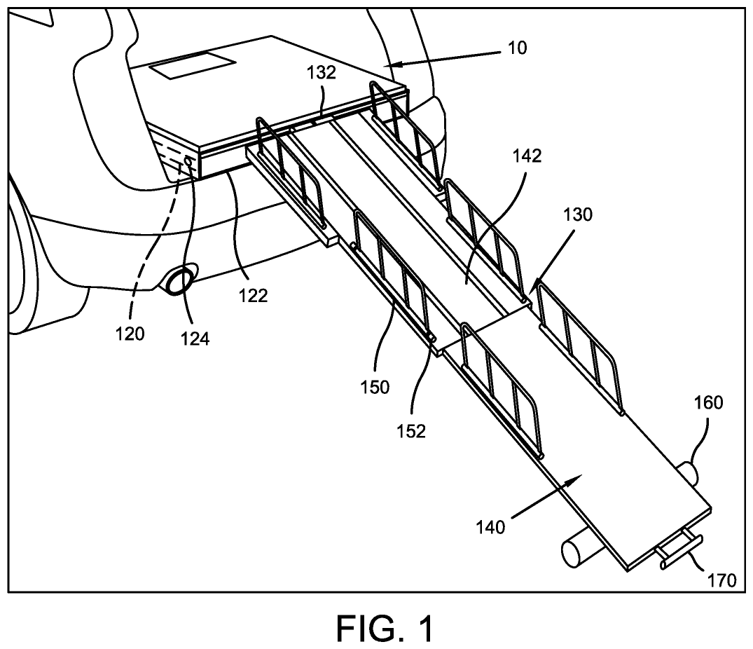

Referring initially to the drawings, FIG. 1 illustrates a perspective view of one potential embodiment of a vehicle pet ramp device 100 of the present invention while in a vehicle cargo space 10 with the ramp 130 extended in accordance with the disclosed architecture. The device 100 is primarily comprised of housing 110 with a padded top surface 116 and a ramp 130 that can be extended from and retracted into the housing 110. The device 100 allows a pet to easily walk into the cargo space 10 of a vehicle. All components of the device 100 are comprised of a rigid Kevlar like plastic and/or lightweight metal material, stainless steel, etc.

The housing 110 is preferably square or rectangular in shape. However, the housing 110 may be any shape with an interior space 114 that can house the ramp 130 when not in use. The housing 110 may be any shape such that it fits within the cargo space 10 or bed of a vehicle.

The top surface 116 of the housing 110 is preferably comprised of a padding 118 or a cushioning. The padding 118 is preferably waterproof to protect against urination/drooling and may be any foam padding, stuffing, or cushioning or padding material known in the art. The top surface 116 serves as an area where a pet can sit or lay within the trunk 10. The padding 118 is preferably removably attached to the top surface 116 via at least one fastener 119 to allow the padding 118 to be removed for easy cleaning. The fastener 119 may be any fastener known in the art such as, but not limited to, hook and loop, magnetic, adhesive, etc.

The housing 110 is comprised of at least one opening 112. The opening 112 allows the ramp 130 to be pulled from or retracted into the interior space 114 of the housing 110 during use. In one embodiment, the ramp 130 attaches to at least one internal frame member 122 within the interior space 114. The frame member 122 is preferably attached to a movable rack 120 within the interior space 114. The track 120 allows the ramp 130 to be pulled out from and pushed back into the housing 110. In one embodiment, the track 120 is a spring-loaded track that facilitates the assisting of extending/retracting the ramp 130.

The ramp 130 allows a pet to travel from a ground surface into the cargo space 10 of the vehicle via walking. The ramp 130 may articulate a plurality of angles via at least one attachment hinge 132 that connects the ramp 130 to the internal frame member 122. The hinge 132 may be any type known in the art such as, but not limited to, a locking hinge. In one embodiment, the track 120 may be comprised of a locking mechanism 124 that locks the position of the frame member 122 on the track 120. This prevents the ramp 130 from moving on the track 120 while in use.

The top surface 140 of the ramp 130 is comprised of at least one traction material 142. The material allows a pet to obtain adequate grip while walking on the ramp 130. The material 142 is preferably a granulated material but may be any grip material known in the art. The ramp 130 may also be comprised of at least one side rail 150 that prevents a pet from falling off the ramp 130 while traveling up the ramp 130. The side rail 150 may be attached to the ramp 130 via at least one hinge 152 (of any type known in the art) to allow the side rail 150 to fold when not in use. In this manner, the side rail 150 can be folded to allow the ramp 130 to be stored within the interior space 114.

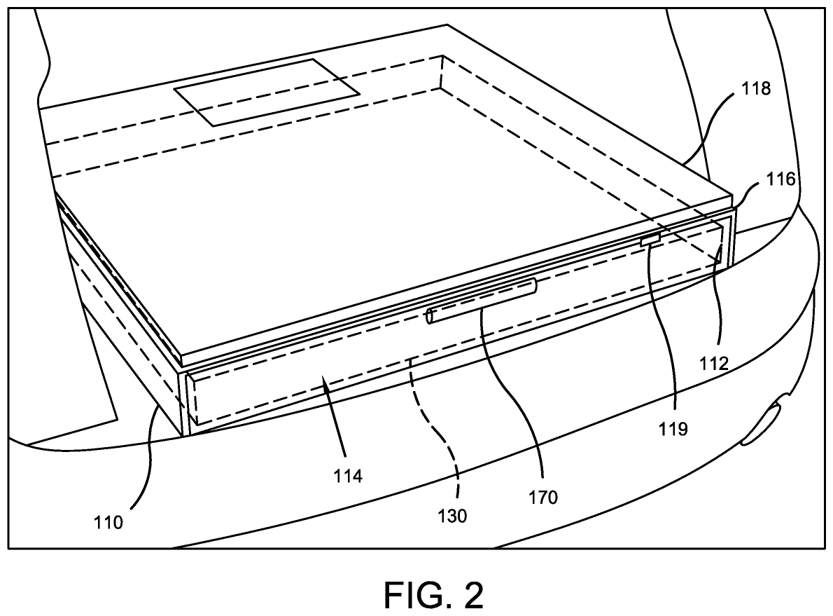

The ramp 130 may also be comprised of at least one support member 160 positioned at the end of the ramp 130 to further stabilize the ramp 130. The support member 160 may be weighted or may be any type of stabilizing structure known in the art. The ramp 130 may also be comprised of at least one handle 170 that allows the ramp 130 to be pushed/pulled from the housing 110. The ramp 130 itself is preferably a telescopic ramp body 130 or a folding ramp body 130 to allow the ramp 130 to be easily stored within the interior space 114, as seen in FIG. 2.

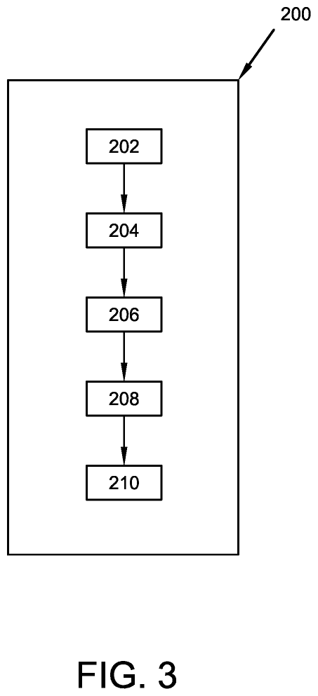

The present invention is also comprised of a method of using 200 the device 100, as seen in FIG. 3. First, a device 100 is provided comprised of housing 110 with a top surface 116 comprised of a padding 118 and an interior space 114, and a ramp 130 that attaches to the housing [Step 202]. Then, a user can place the housing 110 within a cargo area 10 of a vehicle [Step 204]. Next, a user can pull the ramp 130 out of an interior space 114 of the housing 110 via a handle 170 of the ramp 130 and place the ramp on a ground surface [Step 206]. Then, the side rail 150 can be unfolded upward such that it stands vertical in relation to the ramp 130 [Step 208]. After a pet has walked up the ramp 130, a user can fold the side rail 150, such that it rests flat against the ramp 130, and the ramp 130 can be pushed back into the interior space 114 of the housing 110 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle pet ramp device” and “device” are interchangeable and refer to the vehicle pet ramp device 100 of the present invention.

Notwithstanding the foregoing, the vehicle pet ramp device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle pet ramp device 100 as shown in the FIGS. are for illustrative purposes only, and that many other sizes and shapes of the vehicle pet ramp device 100 are well within the scope of the present disclosure. Although the dimensions of the vehicle pet ramp device 100 are important design parameters for user convenience, the vehicle pet ramp device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle pet ramp device comprising:
a housing comprised of a top surface and an interior space;
a padding;
a track;
a fastener;
a ramp comprised of a handle and a first hinge;
a side wall attached to the ramp via a second hinge.

2. The vehicle pet ramp device of claim 1, wherein the fastener attaches to the padding and the top surface.

3. The vehicle pet ramp device of claim 1, wherein the first hinge is comprised of a locking hinge.

4. The vehicle pet ramp device of claim 1, wherein the second hinge is comprised of a locking hinge.

5. The vehicle pet ramp device of claim 1, wherein the ramp is comprised of a folding ramp.

6. The vehicle pet ramp device of claim 1, wherein the first hinge is comprised of a telescopic ramp.

7. A vehicle pet ramp device comprising:
a housing comprised of a top surface and an interior space;
a padding;
a track positioned in the interior space;
a fastener;
a ramp comprised of a top surface having a traction material, and a handle;
a first hinge; and
a side wall attached to the ramp via a second hinge.

8. The vehicle pet ramp device of claim 7, wherein the ramp is comprised of a folding ramp.

9. The vehicle pet ramp device of claim 7, wherein the ramp is comprised of a telescopic ramp.

10. The vehicle pet ramp device of claim 7, wherein the fastener attaches to the padding and the top surface.

11. The vehicle pet ramp device of claim 10, wherein the fastener is comprised of a hook and loop fastener.

12. The vehicle pet ramp device of claim 7, wherein the traction material is comprised of a granulated material.

13. The vehicle pet ramp device of claim 7, wherein the padding is comprised of a waterproof padding.

14. The vehicle pet ramp device of claim 7 further comprised of a support member.

15. The vehicle pet ramp device of claim 14, wherein the support member attaches to the ramp.

16. The vehicle pet ramp device of claim 7, wherein the track is comprised of a spring-loaded track.

17. The vehicle pet ramp device of claim 7, wherein the track is comprised of a locking mechanism that stops the movement of the track.

18. The vehicle pet ramp device of claim 7 further comprised of an internal frame member.

19. The vehicle pet ramp device of claim 7, wherein the internal frame member attaches to the track and to the first hinge.

20. A method of using a vehicle pet ramp device, the method comprising the steps of:
providing a vehicle pet ramp device comprised of a housing comprised of an interior space and a top surface comprised of a padding, and a ramp that attaches to the housing;
placing the housing within a trunk of a vehicle;
pulling the ramp out of the interior space and placing the ramp on a ground surface;
unfolding a side rail;
folding a side rail; and
pushing the ramp back into the interior space.
